(19) United States
(12) Patent Application Publication
(10) Pub. No.: US 2012/0328900 A1
(43) Pub. Date: Dec. 27, 2012

(54) Alloy, protective layer, and component

(76) Inventors: Friedhelm Schmitz, Dinslaken (DE); Werner Stamm, Mulheim an der Ruhr (DE)

(21) Appl. No.: 13/521,245

(22) PCT Filed: Jan. 10, 2011
(86) PCT No.: PCT/EP11/50221

§ 371 Date: Jul. 10, 2012

(30) Foreign Application Priority Data
Jan. 12, 2010 (EP) 10000223.7

(51) Int. Cl. C22C 19/05; C22C 30/00; B32B 15/04

(52) U.S. Cl. 428/621; 420/443; 420/588

(57) ABSTRACT

Known protective layers having a high chromium content, as well as silicon, have brittle phases that become additionally brittle under the influence of carbon during use. A protective layer including the composition of 18% to 20% cobalt, 6% to 8% aluminum, 0.5% to 0.7% yttrium, 22% to 26% chromium, and the remainder nickel is provided.

### CROSS REFERENCE TO RELATED APPLICATIONS

This application is the US National Stage of International Application No. PCT/EP2011/050221, filed Jan. 10, 2011 and claims the benefit thereof. The International Application claims the benefits of European Patent Office application No. 10000223.7 EP filed Jan. 12, 2010. All of the applications are incorporated by reference herein in their entirety.

### FIELD OF INVENTION

The invention relates to an alloy as claimed in the claims, to a protective layer for protecting a component against corrosion and/or oxidation, in particular at high temperatures, as claimed in the claims and to a component as claimed in the claims.

### BACKGROUND OF INVENTION

Large numbers of protective layers for metal components, which are intended to increase their corrosion resistance and/or oxidation resistance, are known in the prior art. Most of these protective layers are known by the generic name MCrAlY, where M stands for at least one of the elements from the group comprising iron, cobalt and nickel and other essential constituents are chromium, aluminum and yttrium.

Typical coatings of this type are known from U.S. Pat. Nos. 4,005,989 and 4,034,142.

The addition of rhenium (Re) to NiCoCrAlY alloys is also known.

The endeavor to increase the intake temperatures both in static gas turbines and in aircraft engines is of great importance in the specialist field of gas turbines, since the intake temperatures are important determining quantities for the thermodynamic efficiencies achievable with gas turbines. Intake temperatures significantly higher than 1000° C. are possible when using specially developed alloys as base materials for components to be heavily loaded thermally, such as guide vanes and rotor blades, in particular by using single-crystal superalloys. To date, the prior art permits intake temperatures of 950° C. or more for static gas turbines and 1100° C. or more in gas turbines of aircraft engines.

Examples of the structure of a turbine blade with a single-crystal substrate, which in turn may be complexly constructed, are disclosed by WO 91/01433 A1.

While the physical loading capacity of the base materials so far developed for the components to be heavily loaded is substantially unproblematic in respect of possible further increases in the intake temperatures, it is necessary to resort to protective layers in order to achieve sufficient resistance against oxidation and corrosion. Besides sufficient chemical stability of a protective layer under the aggressions which are to be expected from exhaust gases at temperatures of the order of 1000° C., a protective layer must also have sufficiently good mechanical properties, not least in respect of the mechanical interaction between the protective layer and the base material. In particular, the protective layer must be ductile enough to be able to accommodate possible deformations of the base material and not crack, since points of attack would thereby be provided for oxidation and corrosion.

### SUMMARY OF INVENTION

It is therefore an object of the invention to provide an alloy and a protective layer, having good high-temperature resistance to corrosion and oxidation, has good longterm stability and which is furthermore adapted particularly well to a mechanical load which is to be expected particularly in a gas turbine at a high temperature.

The object is achieved by an alloy as claimed in the claims and a protective layer as claimed in the claims.

It is another object of the invention to provide a component which has increased protection against corrosion and oxidation.

The object is likewise achieved by a component as claimed in the claims, in particular a component of a gas turbine or steam turbine, which comprises a protective layer of the type described above for protection against corrosion and oxidation at high temperatures.

Further advantageous measures, which may advantageously be combined with one another in any desired way, are listed in the dependent claims.

The invention is based inter alia on the discovery that the protective layer exhibits brittle rhenium precipitates in the layer and in the transition region between the protective layer and the base material. These brittle phases, which are formed increasingly over time and with the temperature during use, lead during operation to very pronounced longitudinal cracks in the layer as well as in the layer-base material interface, with subsequent shedding of the layer. The brittleness of the rhenium precipitates is further increased by the interaction with carbon, which can diffuse into the layer from the base material or diffuses into the layer through the surface during a heat treatment in the furnace. The impetus to cracking is further enhanced by oxidation of the rhenium phases.

The invention will be explained in more detail below.

### BRIEF DESCRIPTION OF THE DRAWINGS

FIG. 1 shows a layer system with a protective layer,

FIG. 2 shows compositions of superalloys,

FIG. 3 shows a gas turbine,

FIG. 4 shows a turbine blade and

FIG. 5 shows a combustion chamber.

The figures and the description merely represent exemplary embodiments of the invention.

### DETAILED DESCRIPTION OF INVENTION

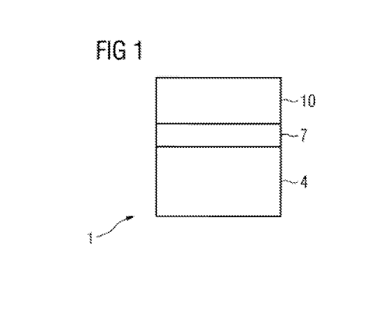

According to the invention, a protective layer 7 (FIG. 1) for protecting a component against corrosion and oxidation at a high temperature essentially comprises the following elements (proportions indicated in wt %):

from 18% to 22% cobalt (Co),
from 6% to 8% aluminum (Al),
from 0.5% to 0.7% yttrium (Y) and/or at least one equivalent metal from the group
comprising scandium and the rare earth elements,
from 22% to 20% chromium (Cr),

### Nickel (Ni) (NiCoCrAlY).

This listing is not exhaustive.

An advantageous embodiment consists of the elements nickel, cobalt, chromium, aluminum and yttrium.

In the case of a relatively high oxidation stress (pure combustion gas), more oxygen has to be bound by yttrium in order for the protective aluminum oxide layer not to be able to grow too quickly, with the yttrium value then advantageously being up to 0.7 wt %. However, the yttrium content of the alloy must generally not be too high since this otherwise leads to embrittlement.

A preferred exemplary embodiment is:

Ni-20Co-24Cr-7Al-0.6Y.

It is to be noted that the proportions of the individual elements are specially adapted with a view to their effects, which are to be seen particularly in connection with the element rhenium which is not present. If the proportions are dimensioned in such a way, the addition of rhenium (Re) can be dispensed with, so that no rhenium precipitates are formed either. Advantageously no brittle phases are created during use of the protective layer so that the operating time performance is improved and extended.

In conjunction with the reduction of the brittle phases, which have a detrimental effect particularly with high mechanical properties, the reduction of the mechanical stresses due to the selected nickel content improves the mechanical properties.

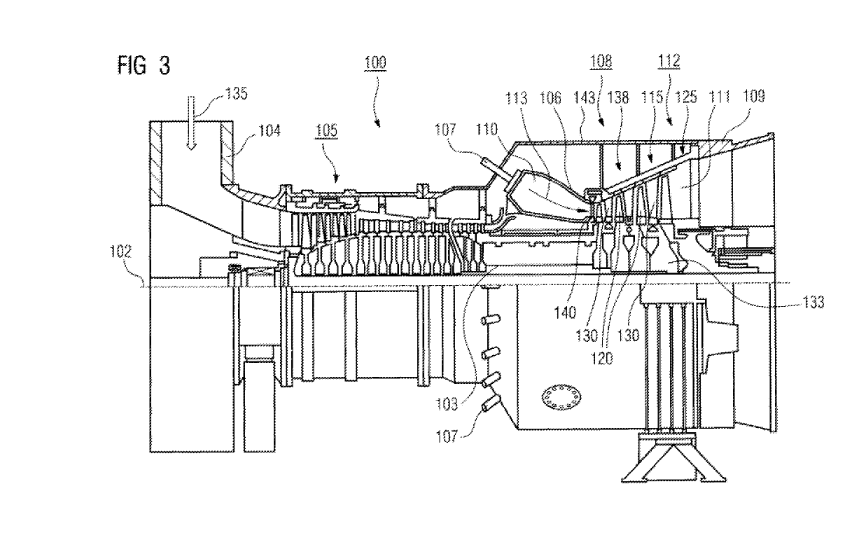

With good corrosion resistance, the protective layer has particularly good resistance against oxidation and is also distinguished by particularly good ductility properties, so that it is particularly qualified for use in a gas turbine 100 (FIG. 3) with a further increase in the intake temperature.

The powders are for example applied by plasma spraying (APS, LPPS, VPS, etc.). Other methods may likewise be envisaged (PVD, CVD, cold gas spraying, etc.).

The described protective layer 7 also acts as a layer which improves adhesion to the superalloy.

Preference is given to only a single protective layer 7 being used for the component, thus no duplex layer being used for the bondcoat.

Further layers, in particular ceramic thermal barrier layers 10, may be applied onto this protective layer 7.

In a component 1, the protective layer 7 is advantageously applied onto a substrate 4 made of a nickel-based or cobalt-based superalloy.

The following composition in particular may be suitable as substrate (data in wt %):

from 0.1% to 0.15% carbon
from 18% to 22% chromium
from 18% to 19% cobalt
from 0% to 2% tungsten
from 0% to 4% molybdenum
from 0% to 1.5% tantalum
from 0% to 1% niobium
from 1% to 3% aluminum
from 2% to 4% titanium
from 0% to 0.75% hafnium,
optionally small proportions of boron and/or zirconium, remainder nickel.

Compositions of this type are known as casting alloys under the references GDT222, IN939, IN6203 and Udimet 500.

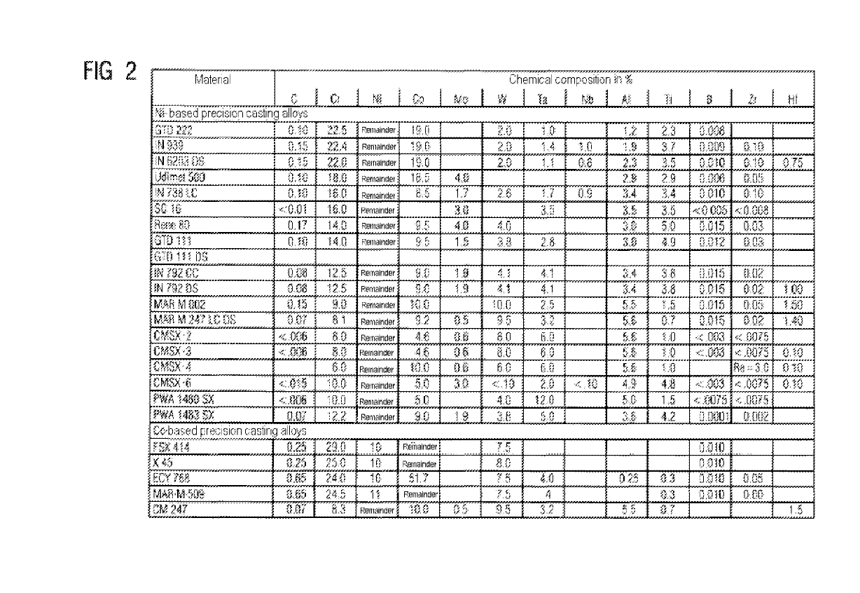

Other alternatives for the substrate 4 of the component 1, 120, 130, 155 are listed in FIG. 2.

The thickness of the protective layer 7 on the component 1 is preferably dimensioned with a value of between about 100 μm and 300 μm.

The protective layer 7 is particularly suitable for protecting the component 1, 120, 130, 155 against corrosion and oxidation while the component is being exposed to an exhaust gas at a material temperature of about 950° C., or even about 1100° C. in aircraft turbines.

The protective layer 7 according to the invention is therefore particularly qualified for protecting a component of a gas turbine 100, in particular a guide vane 120, rotor blade 130 or a heat shield element 155, which is exposed to hot gas before or in the turbine of the gas turbine 100 or of the steam turbine.

The protective layer 7 may be used as an overlay (the protective layer is the outer layer) or as a bondcoat (the protective layer is an interlayer).

It is preferably used as a “single” layer, i.e. there is no further metallic layer.

FIG. 1 shows a layer system 1 as a component.

The layer system 1 consists of a substrate 4.

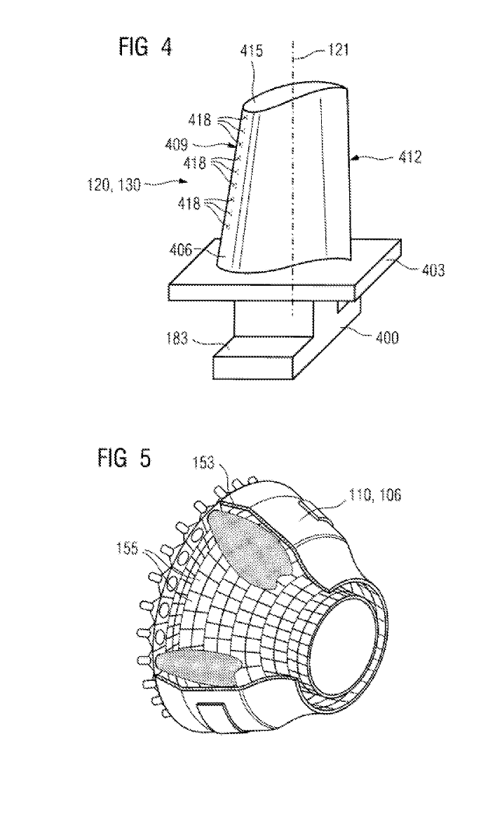

The substrate 4 may be metallic and/or ceramic. Particularly in the case of turbine components, for example turbine rotor blades 120 (FIG. 4) or guide vanes 130 (FIGS. 3, 4), heat shield elements 155 (FIG. 5) or other housing parts of a steam or gas turbine 100 (FIG. 3), the substrate 4 consists of a nickel-, cobalt- or iron-based superalloy.

Nickel-based superalloys are preferably used.

The protective layer 7 according to the invention is provided on the substrate 4. It is preferably used as a “single” layer, i.e. there is no further metallic layer.

This protective layer 7 is preferably applied by plasma spraying (VPS, LPPS, APS, etc.).

It may be used as an outer layer (not shown) or interlayer (FIG. 1).

In the latter case, there will be a ceramic thermal barrier layer 10 on the protective layer 7.

The protective layer 7 may be applied onto newly produced components and refurbished components.

Refurbishment means that components 1 are separated if need be from layers (thermal barrier layer) after their use and corrosion and oxidation products are removed, for example by an acid treatment (acid stripping). It may sometimes also be necessary to repair cracks. Such a component may subsequently be recoated, since the substrate 4 is very expensive.

FIG. 3 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fitted on the rotor 103, for example by means of a turbine disk 133.

Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

The components exposed to the hot working medium 113 experience thermal loads during operation of the gas turbine 100. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

The substrates may likewise comprise a directional structure, i.e. they are single-crystal (SX structure) or comprise only longitudinally directed grains (DS structure).

Iron-, nickel- or cobalt-based superalloys are for example used as the material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949.

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

FIG. 4 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

The blade 120, 130 comprises, successively along the longitudinal axis 121, a fastening zone 400, a blade platform 403 adjacent thereto as well as a blade surface 406 and a blade tip 415.

As a guide vane 130, the vane 130 may have a further platform (not shown) at its vane tip 415.

A blade root 183 which is used to fasten the rotor blades 120, 130 on a shaft or a disk (not shown) is formed in the fastening zone 400.

The blade root 183 is configured, for example, as a hammerhead. Other configurations as a firtree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949.

The blade 120, 130 may in this case be manufactured by a casting method, also by means of directional solidification, by a forging method, by a machining method or combinations thereof.

Workpieces with a single-crystal structure or single-crystal structures are used as components for machines which are exposed to heavy mechanical, thermal and/or chemical loads during operation.

Such single-crystal workpieces are manufactured, for example, by directional solidification from the melts. These are casting methods in which the liquid metal alloy is solidified to form a single-crystal structure, i.e. to form the single-crystal workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a single-crystal structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or single-crystal component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1.

The blades 120, 130 may also have layers 7 according to the invention protecting against corrosion or oxidation.

The density is preferably 95% of the theoretical density.

A protective aluminum oxide layer (TGO=thermally grown oxide layer) is formed on the MCrAlX layer (as an interlayer or as the outermost layer).

On the MCrAlX, there may furthermore be a thermal barrier layer, which is preferably the outermost layer and consists for example of ZrO₂, Y₂O₃-ZrO₂, i.e. it is not stabilized or is partially or fully stabilized by yttrium oxide and/or calcium oxide and/or magnesium oxide.

The thermal barrier layer covers the entire MCrAlX layer.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance. The thermal barrier layer is thus preferably more porous than the MCrAlX layer.

The blade 120, 130 may be designed to be hollow or solid.

If the blade 120, 130 is intended to be cooled, it will be hollow and optionally also comprise film cooling holes 418 (indicated by dashes).

FIG. 5 shows a combustion chamber 110 of the gas turbine 100. The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, of about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Owing to the high temperatures inside the combustion chamber 110, a cooling system may also be provided for the heat shield elements 155 or for their retaining elements. The heat shield elements 155 are then hollow, for example, and optionally also have cooling holes (not shown) opening into the combustion chamber space 154.

Each heat shield element 155 made of an alloy is equipped with a particularly heat-resistant protective layer (MCrAlX layer and/or ceramic coating) on the working medium side, or is made of refractory material (solid ceramic blocks).

These protective layers 7 may be similar to the turbine blades.

On the MCrAlX, there may furthermore be an e.g. ceramic thermal barrier layer which consists for example of ZrO₂, Y₂O₃-ZrO₂, i.e. it is not stabilized or is partially or fully stabilized by yttrium oxide and/or calcium oxide and/or magnesium oxide.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CVD. The thermal barrier layer may comprise porous, micro- or macro-cracked grains for better thermal shock resistance.

Refurbishment means that turbine blades 120, 130 or heat shield elements 155 may need to be stripped of protective layers (for example by sandblasting) after their use. The corrosion and/or oxidation layers or products are then removed. Optionally, cracks in the turbine blade 120, 130 or heat shield element 155 are also repaired. The turbine blades 120, 130 or heat shield elements 155 are then recoated and the turbine blades 120, 130 or heat shield elements 155 are used again.

1-11. (canceled)

12. An alloy, comprising: (in wt %):
18%-22% cobalt;
22%-26% chromium;
6%-8% aluminum;
0.5%-0.7% of at least one element selected from the group consisting of scandium and rare earth elements; and
nickel;

13. The alloy as claimed in claim 12, wherein the alloy comprises 19%-21% cobalt (wt %).

14. The alloy as claimed in claim 12, wherein the alloy comprises 23%-25% cobalt (wt %).

15. The alloy as claimed in claim 12, wherein the alloy comprises 6.5%-7.5% aluminum (wt %).

16. The alloy as claimed in claim 12, wherein the alloy comprises 24 wt % chromium.

17. The alloy as claimed in claim 12, wherein the alloy comprises 20 wt % cobalt.

18. The alloy as claimed in claim 12, wherein the alloy comprises 0.6 wt % yttrium.

19. The alloy as claimed in claim 12, wherein the alloy comprises 7 wt % aluminum.

20. The alloy as claimed in claim 12, wherein the alloy does not include rhenium.

21. The alloy as claimed in claim 12, wherein the alloy does not include silicon.

22. The alloy as claimed in claim 12, wherein the alloy does not include an element selected from the group consisting of zirconium, titanium, gallium, germanium, and combinations thereof.

23. The alloy as claimed in claim 12,
consisting of cobalt, chromium, aluminum, yttrium, and nickel.

24. A protective layer for protecting a component against corrosion and/or oxidation, comprising:
an alloy as claimed in claim 12,
wherein the alloy is used at high temperatures, and
wherein the alloy is present as a single layer.

25. A component, comprising:
a substrate that is nickel-based or cobalt-based;
a metallic protective layer as claimed in claim 24; and
a ceramic thermal layer,
wherein the metallic protective layer protects against corrosion and oxidation at high temperatures, and
wherein the ceramic thermal barrier layer is applied onto the protective layer.
